(19) United States
(12) Patent Application Publication
(10) Pub. No.: US 2002/0147966 A1
(43) Pub. Date: Oct. 10, 2002

(54) Operating software performance monitor

(75) Inventor: Ralph E. Frazier, Suwanee, GA (US)

Correspondence Address: Paul W. Martin, NCR Corporation, Law Department, 101 W. Schantz Avenue, ECD-2, Dayton, OH, 45479-0001, US

(73) Assignee: NCR CORPORATION

(21) Appl. No.: 09/782,150

(22) Filed: Feb. 14, 2001

(51) Int. Cl. G06F 9/44

(52) U.S. Cl. 717/127; 717/130

(57) ABSTRACT

A computer implemented method for monitoring and analyzing operating software scheduling information is described. Further, the method adjusts operating software parameters, either manually or automatically, while the system is operational without requiring an external device. The method includes monitoring operating software scheduling information, analyzing operating software scheduling information and adjusting defined operating software parameters to modify system performance.

### RELATED APPLICATION

The present application is related to co-pending patent application entitled, “OPERATING SOFTWARE SCHEDULING PRIORITY RECORDER”, NCR Docket #8605, by the instant inventor which is assigned to the instant assignee and filed on even date herewith and is hereby incorporated by referenced into this specification in its entirety.

### FIELD OF THE INVENTION

The present invention relates generally to obtaining operating software information, and more particularly, to a system and method to analyze operating software performance and to adjust system parameters while “on-line” without external device intervention while the system is operational.

### BACKGROUND OF THE INVENTION

Typical operating systems include a kernel having a variety of functions and services made available to applications, otherwise referred to as software, executable software, programs, tasks, or processes. Among the kernel components is a scheduler for deciding which application (task, process, etc.) to execute or run based on a priority scheme set in the operating system. The runtime priority scheme provides the ability to control or set the importance of an application. The higher the run-time priority, the more time is afforded to the application by the operating system, i.e., operating software. Further, in most cases, a lower priority application which is running will be preempted by the operating system for a higher priority application execution.

Accordingly, program scheduling priority schemes can be based on various approaches, or combination of approaches, such as dynamic, fixed, grouped, and unique priorities. The dynamic priority scheme is an approach where the application scheduling priority is raised or lowered according to the needs of the operating system. A fixed priority scheme is a situation where the application scheduling priority remains constant. An application can have a scheduling priority common to a group of applications. The scheduling priority scheme between applications with identical priorities is first-come, first-served. Also, it is possible for every application accessing the operating system to have a unique scheduling priority. To reiterate, the program scheduling priority scheme is dependent on the design of the operating software. However, the present inventor is unaware of any software built in current operating software for recording, monitoring, and analyzing operating software scheduling information, i.e., counts, variables, or system structures that the operating software updates and maintains in conjunction with program, or application, scheduling.

Prior approaches to obtaining operating software scheduling information have depended on the use of external devices, such as logic analyzers, simulators, or emulators. The external devices are separate, stand-alone computer systems including operating software for obtaining operating software scheduling information from the operating software of a computer system under test. Typically, these devices are either attached to the computer system under test, or the software is imported to the external device. There is a risk that the external device will not behave exactly like the computer system under test. The external devices also add additional expense to a computer system under test. Further, there may not be any external devices available for the specific processor, operating system, or network of the computer system under test. Connecting a device to an installed system is impractical as the installation and/or execution of the device interferes with the operation and use of the system. For example, additional interrupts may be generated for the device and may impact the quality and usefulness of the recorded scheduling information by increasing the system load due to the extra processing necessary to handle the interrupts. One successful approach to solving this problem is described in the co-pending patent application entitled, “OPERATING SOFTWARE SCHEDULING PRIORITY RECORDER” identified above.

Previous approaches to analyzing operating software performance, of which I am currently aware, are performed external to the system being monitored and after completion of the execution of the operating software being monitored. Further, any adjustments to operating software performance are typically made after the fact, i.e., after the software has completed execution on the computer system and an analysis has been performed using the external device executing the same operating software. The information gained by such methods is typically not immediately available or applicable to the recently completed software execution. That is, the feedback and/or information necessary for a user or software-initiated modification of system parameters is not available during the time when the information or feedback is needed most.

If the information were available during execution, an audio or visual alert could be used to provide feedback to a user indicating current system performance, e.g., too busy, idle, or other operating conditions. In response to such feedback, a user could alter the priority scheme employed by the operating software or delay the restart of selected programs based on additional parameters. Additionally, unnecessary or idle programs could be terminated freeing up additional resources, or load balancing could be performed migrating additional programs to the system from an overloaded system. Thus, there is a need in the art to analyze operating software performance without an external device while the system is operational and a further need to adjust operating software parameters as a result of such analysis.

### SUMMARY OF THE INVENTION

It is, therefore, an object of the present invention to provide a method and apparatus for analyzing operating software performance without external device intervention while the system is operational.

It is another object of the present invention to provide a method and apparatus for adjusting operating software performance without an external device while the system is operational.

It is another object of the present invention to provide a method and apparatus for providing feedback to a user or software regarding operating software performance without requiring an external device while the system is operational.

These and other objects of the present invention are achieved by a method for monitoring and analyzing operating software scheduling information. The method adjusts defined operating software parameters to modify system performance.

The foregoing and other objects of the present invention are achieved by an apparatus of the above method including a processor for receiving and transmitting data and a memory coupled to the processor. The memory has sequences of instructions stored which, when executed by the processor, cause the processor to analyze operating software scheduling information and adjust defined parameters to modify system performance.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious respects, all without departing from the invention. Accordingly, the drawings and description thereof are to be regarded as illustrative in nature, and not as restrictive.

### BRIEF DESCRIPTION OF THE DRAWINGS

The present invention is illustrated by way of example, and not by limitation, in the figures of the accompanying drawings, wherein elements having the same reference numeral designations represent like elements throughout and wherein:

FIG. 1 is a high level block diagram of a computer architecture usable with the present invention;

FIG. 2 is a high level functional diagram of the present invention; and

FIG. 3 is a high level flow diagram of an embodiment of the present invention.

### BEST MODE FOR CARRYING OUT THE INVENTION

A method and apparatus for analyzing, and adjusting operating software performance without external device intervention while the system is operational are described. In the following description, for purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

Hardware Overview

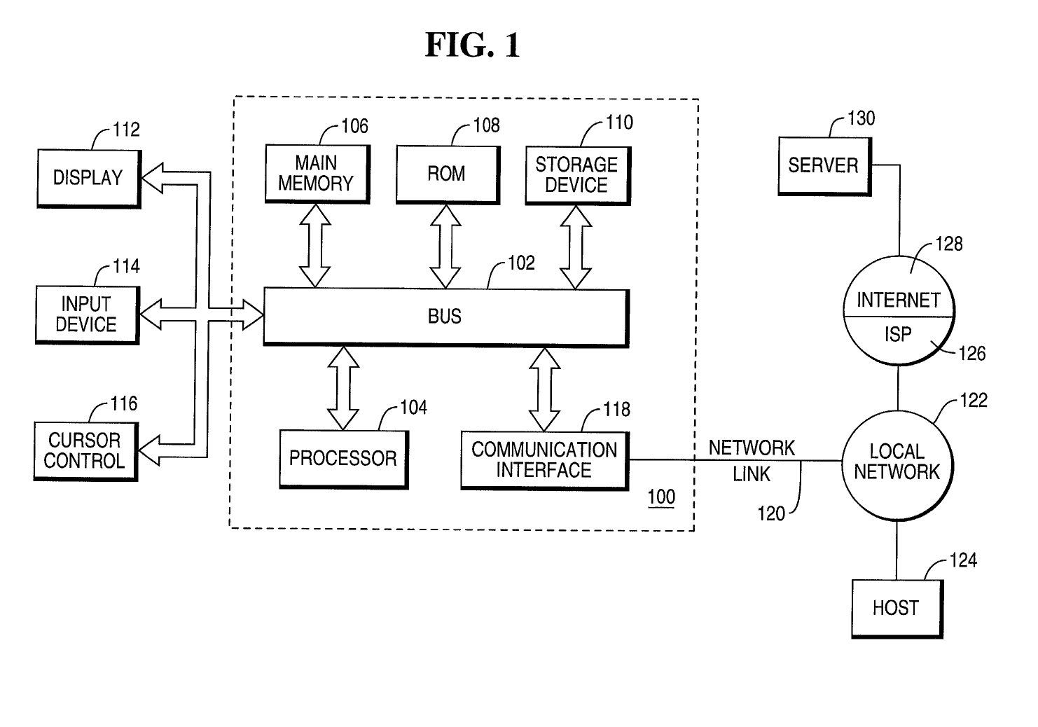

FIG. 1 is a block diagram illustrating an exemplary computer system 100 upon which an embodiment of the invention may be implemented. The present invention is usable with currently available personal computers, mini-mainframes and the like.

Computer system 100 includes a bus 102 or other communication mechanism for communicating information, and a processor 104 coupled with the bus 102 for processing information. Computer system 100 also includes a main memory 106, such as a random access memory (RAM) or other dynamic storage device, coupled to the bus 102 for storing information and instructions to be executed by processor 104. Main memory 106 also may be used for storing temporary variables or other intermediate information during execution of instructions to be executed by processor 104. Computer system 100 further includes a read only memory (ROM) 108 or other static storage device coupled to the bus 102 for storing static information and instructions for the processor 104. A storage device 110, such as a magnetic disk or optical disk, is provided and coupled to the bus 102 for storing information and instructions.

Computer system 100 may be coupled via the bus 102 to a display 112, such as a cathode ray tube (CRT) or a flat panel display, for displaying information to a computer user. An input device 114, including alphanumeric and other keys, is coupled to the bus 102 for communicating information and command selections to the processor 104. Another type of user input device is cursor control 116, such as a mouse, a trackball, or cursor direction keys for communicating direction information and command selections to processor 104 and for controlling cursor movement on the display 112. This input device typically has two degrees of freedom in two axes, a first axis (e.g., x) and a second axis (e.g., y) allowing the device to specify positions in a plane.

The invention is related to the use of a computer system 100, such as the illustrated system, to analyze operating software performance information and adjust system parameters without external device intervention with the system is running. According to one embodiment of the invention, analysis of operating software performance information and adjustment of system parameters is provided by computer system 100 in response to processor 104 executing sequences of instructions contained in main memory 106. Such instructions may be read into main memory 106 from another computer-readable medium, such as storage device 110. However, the computer-readable medium is not limited to devices such as storage device 110. For example, the computer-readable medium may include a floppy disk, a flexible disk, hard disk, magnetic tape, or any other magnetic medium, a CD-ROM, any other optical medium, punch cards, paper tape, any other physical medium with patterns of holes, a RAM, a PROM, an EPROM, a FLASH-EPROM, any other memory chip or cartridge, a carrier wave embodied in an electrical, electromagnetic, infrared, or optical signal, or any other medium from which a computer can read. Execution of the sequences of instructions contained in the main memory 106 causes the processor 104 to perform the process steps described below. In alternative embodiments, hard-wired circuitry may be used in place of or in combination with computer software instructions to implement the invention. Thus, embodiments of the invention are not limited to any specific combination of hardware circuitry and software.

Computer system 100 also includes a communication interface 118 coupled to the bus 102. Communication interface 108 provides a two-way data communication as is known. For example, communication interface 118 may be an integrated services digital network (ISDN) card or a modem to provide a data communication connection to a corresponding type of telephone line. As another example, communication interface 118 may be a local area network (LAN) card to provide a data communication connection to a compatible LAN. In the preferred embodiment communication interface 118 is coupled to a virtual blackboard. Wireless links may also be implemented. In any such implementation, communication interface 118 sends and receives electrical, electromagnetic or optical signals which carry digital data streams representing various types of information. Of particular note, the communications through interface 118 may permit transmission or receipt of the operating software performance information. For example, two or more computer systems 100 may be networked together in a conventional manner with each using the communication interface 118.

Network link 120 typically provides data communication through one or more networks to other data devices. For example, network link 120 may provide a connection through local network 122 to a host computer 124 or to data equipment operated by an Internet Service Provider (ISP) 126. ISP 126 in turn provides data communication services through the world wide packet data communication services through the world wide packet data communication network now commonly referred to as the “Internet” 128. Local network 122 and Internet 128 both use electrical, electromagnetic or optical signals which carry digital data streams. The signals through the various networks and the signals on network link 120 and through communication interface 118, which carry the digital data to and from computer system 100, are exemplary forms of carrier waves transporting the information.

Computer system 100 can send messages and receive data, including program code, through the network(s), network link 120 and communication interface 118. In the Internet example, a server 130 might transmit a requested code for an application program through Internet 128, ISP 126, local network 122 and communication interface 118. In accordance with the invention, one such downloaded application provides for information discovery and visualization as described herein.

The received code may be executed by processor 104 as it is received, and/or stored in storage device 110, or other non-volatile storage for later execution. In this manner, computer system 100 may obtain application code in the form of a carrier wave.

Though the present invention is equally applicable to the standard computer system described in detail above, a preferred embodiment, as described below, is used in conjunction with an embedded system, i.e., a standard grocery store bar code scanner. The standard scanner lacks certain portions of the computer system described in connection with FIG. 1 above. For example, there is no display 112 or cursor control 116 in the typical scanner setup. Further, there may or may not be a storage device 110 and communication interface 118. In normal or typical setups, the input device 114 is a laser or other scanning device to read bar code information off scanned products and the bar code information is then provided via communication interface 118 to a point of sale terminal, similar to the computer system of FIG. 1. Alternatively, the bar code information may be provided to the point of sale terminal directly over bus 102.

Additionally, special purpose embedded or real-time operating systems (operating software) are typically used to control scanners of the type described above.

The Operating Software Performance Monitor (OSPM) of the present invention analyzes real-time performance data as the system is running without the use of an external device. Further, the OSPM is able to adjust system parameters in response to the analysis performed.

The following definitions are used herein:

The operating software can be either an operating system or an operating or executing application.

Programs are applications, tasks, or processes that execute within the operating software environment.

Run-time priority is the importance of a program's scheduling and execution relative to other programs in the system. The operating software uses the run-time priority to determine which program to execute on the computer device.

The scheduling information can be a count, a variable, or a system structure that the operating software updates and maintains in conjunction with the scheduling of a program.

Program preemption is an action performed by the operating software suspending a program such that control is given to another program with a higher run-time priority.

A ledger is the location and information content accessed and analyzed by the operating software performance monitor.

The Application Programming Interfaces (API) are the methods and/or guidelines defined by the operating software that allow user programs to access the operating software's services.

The idle loop refers to a point, a program or a routine that is executed when the system is inactive. In this condition, the system is not busy or it is performing low-level background diagnostics. The idle loop is exited when an event occurs which triggers the operating software to run another program.

The performance information specified by this invention disclosure includes, but is not limited to, the tracking and reporting of the following information:

Minimum and peak loads on the system.

Total processing utilization including the information for every running program.

Specific program processing utilization.

Program switch performance.

Interrupt service performance.

Idle time.

When configured, the operating software scheduling priority recorder records program schedule information for a defined period. The period of recording can range from a specified event or period to the entire lifetime of the system.

The performance monitoring of the operating software performance monitor can be configured for a specified time period or continuously active. These configuration options are accessed by means of the operating software performance monitor's API.

The operating software performance monitor provides APIs allowing programs to configure/access recording options including:

Selecting the information to be recorded.

Specifying recording period/events.

Controlling the reset/restart of recording.

Specifying the recording media, report types, file names, etc.

Retrieval of program schedule information.

User defined performance information obtained as a consequence of the operating software's program scheduling information and/or the operating software performance monitor” enhancements.

Workload overload threshold alerts. The threshold is represented by the percentage of computer processing unit (CPU) utilization.

Size and number of entries in the ledger.

Continuous, periodic or timed measurements.

Manual or automatic program scheduling priority adjustments.

Manual or automatic program load leveling.

The operating software performance monitor manipulates the data recorded by the operating software scheduling priority recorder and records the resulting information to the ledger. User programs can access the ledger by means of the operating software performance monitor's API. The ledger information includes:

A count of the number of program schedules, program preempts and interrupts.

The highest priority attained, program identity and length of run-time.

The lowest priority attained, program identify and length of run-time.

Number of times and duration in the idle loop and length of run-time.

A sequential record of scheduled programs, priorities and events (interrupts, preempts, etc.).

The number and identity of programs waiting to run at the time of each schedule.

Using this data, the operating software performance monitor is able to calculate particular values such as the systems processing capabilities, the number of programs scheduled, their run-time priorities, the amount of time spent in each program, the number of preemptions, the number of interrupts and the amount of idle time.

The operating software performance monitor and/or the interfacing application can alert the user via audio or visual feedback when the system becomes too busy, idle or any other condition indicated by the retrieved data.

The operating software performance monitor provides the user with the following:

Manual or automatic scheduling priority adjustments for selected programs for system performance improvements.

Manual or automatic program termination and/or delayed restart for selected programs with qualifying parameters such as run-time priority or CPU utilization.

Build and save various performance profiles based on workload.

System characterization.

Manual or automatic distribution of program execution to improve system efficiency, i.e., program load leveling.

Reports that include the maximum number of programs scheduled to run and their percentage/times of processor utilization for a configured period of time.

It is important to note that each of the above-stated functionalities is obtained or performed by an extension of the kernel and does not require rehosting of software or the attachment of external devices.

The OSPM 210 adjusts process priorities for system performance improvements. For example, the OSPM 210 may raise the priority of lower priority processes to allow them to execute to completion without preemption thereby clearing lower priority preempted processes prior to process starvation. The process priority adjustments may be performed either automatically or manually by a user.

Further, specific programs or processes are terminated and/or delayed or restarted depending on specified parameters, such as run-time priority or CPU utilization. Various performance profiles are generated and saved by the OSPM 210 based on the workload of the computer system 100.

The OSPM 210 manually upon user initiation, or automatically based on predetermined parameters, distributes program execution to improve system efficiency, i.e., program load leveling.

The OSPM 210 generates reports, including the maximum number of programs scheduled to run and corresponding percentage/times of processor utilization for a configured period of time.

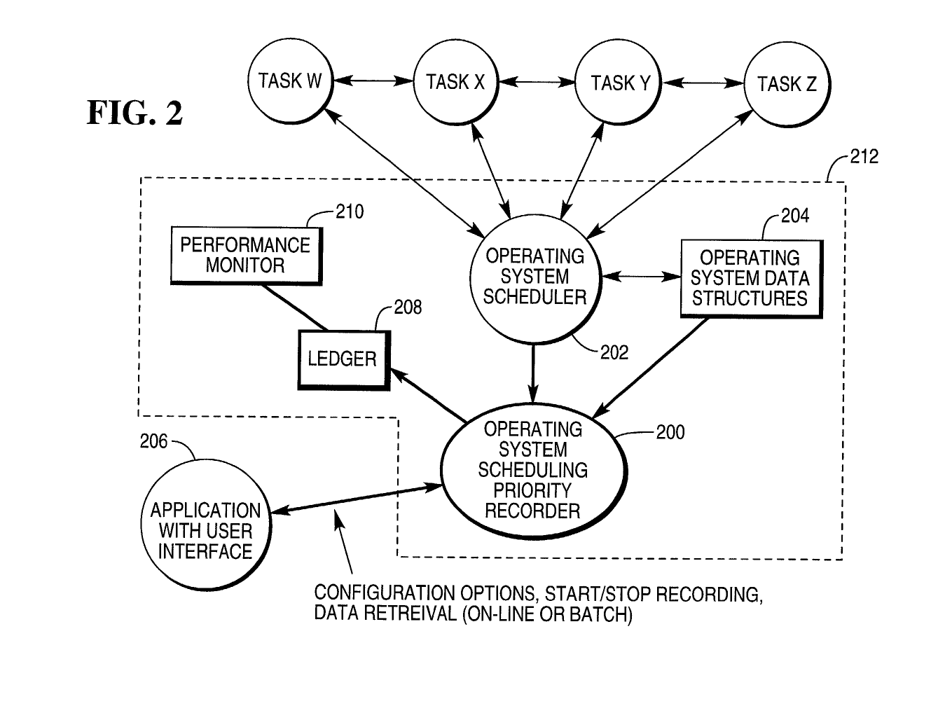

FIG. 2 is a high level functional diagram of the OSSPR 200 within a kernel 212 of a computer system. Included within the kernel 212 is an operating system scheduler 202, operating system data structures 204, a user level application 206, and a ledger 208. Tasks W-Z interact with operating system scheduler 202 and operating system scheduler 202 interacts with operating system data structures 204.

The OSSPR 200 records the history of operating software events as they occur. The OSSPR 200 records program scheduling, program switching, program preemption, interrupts. Details such as task identification, task priority, and runtime length are included within the historic information stored in ledger 208. The OSSPR 200 is designed to be integrated within the target operating system's kernel, and in particular, with the operating system scheduler 202, as shown in FIG. 2. This enables a user to assess the behavior of a computer system, described in detail above, as a whole. Since the OSSPR 200 and OSPM 210 exist as extensions to the operating system, a separate external device such as an emulator is not required to obtain, monitor, and analyze this crucial historical information by a systems analyst.

Functional Overview

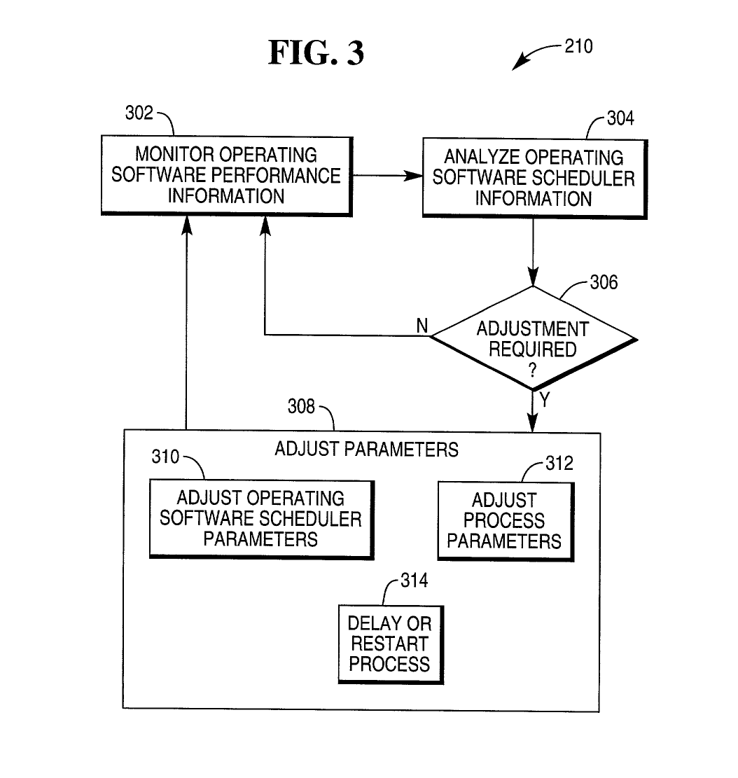

FIG. 3 is a high level flow diagram of the operation of a portion of OSPM 210. At step 302, the OSPM 210 monitors the operating software performance information recorded in ledger 208, as described in detail above. Upon invocation by a user or automatically, according to predetermined parameters, e.g., preset number of timer ticks, execution of a task switch, the flow of control proceeds to step 304.

The OSPM 210 analyzes the operating software scheduling information, described above, and proceeds to step 306. At step 306, a determination is made according to preset specifications whether to make adjustments to the parameters of the operating software. In an alternate embodiment, the OSPM 210 presents the user with the information resulting from step 304 and requests the user to decide whether adjustments are to be made. In further alternate embodiments, the user may specify which adjustments are to be made to the operating software.

If an adjustment is determined to not be required, as a result of step 306, the flow returns to step 302 to again monitor the operating software performance information. If an adjustment is determined to be required, the flow proceeds to step 308 for operating software parameter adjustment.

At step 308, the operating software parameters are adjusted according to the results specified by step 304. After the operating software parameters are adjusted, the flow of control returns to step 302 and the operating software performance information is again monitored.

During execution of step 308, each one, all or any combination of the functions shown in FIG. 3 are executed depending on the adjustment required as determined by step 304. At step 310, the operating software scheduler parameters are adjusted, e.g., the priority scheme employed may be changed from fixed to dynamic. At step 312, the process parameters may be changed, e.g., raising or lowering the priority of a particular process. At step 314, a process may be delayed or restarted.

An example is helpful to illustrate the operation of the present invention. With reference to FIG. 2, a number of tasks Task W-Z are queued up for execution according to a priority scheduling scheme applied by operating system scheduler 202. The operating system scheduler 202 operates in conjunction with operating system data structures 204 to schedule the execution of tasks W-Z. The operating system scheduling priority recorder 200 captures program scheduling information and records the information in the ledger 208. An application 206 interfaces with the operating system scheduling priority recorder 200 to allow a user to set configuration options, start and stop recording or capture of scheduling information, and perform data retrieval. A performance monitor 210 interfaces with the ledger 208 and the operating system scheduler 202 to monitor and adjust performance parameters.

While Task W is executing, the OSPM 210 monitors and analyzes the scheduling information recorded in ledger 208 (steps 302 and 304) and determines that Task W has stalled and is no longer executing. Further, as a result of the nonexecution of Task W, Tasks X, Y, and Z are not able to execute, having a lower priority than Task W. At step 306, the OSPM 210 reports the stall to the user by displaying a message on display 112 and requests the user to select from a list of possible adjustment choices provided on display 112, e.g., do nothing, modify task priorities, delay Task W, or modify scheduler algorithm.

Upon receiving the user's selection via input device 114 or cursor control 116, e.g., delay Task W, the OSPM 210 proceeds to step 308 and performs the selected adjustment. If the user had decided to make no adjustment, the OSPM 210 would return to step 302. Specifically, the OSPM 210 proceeds to step 314 and delays Task W allowing the other Tasks X-Z to execute.

The OSPM 210 flow of control then returns to step 302 to monitor the operating software performance information.

The OSPM 210 code is compiled as an integral part of the operating system kernel and is an extension to the operating system's kernel. The ledger 208 and operating system data structures 204 are shown in FIG. 2 as residing within kernel 210; however, they may be located external of kernel 210 in alternate embodiments.

The residence or location of the ledger 208 storage is optional. The ledger 208 can be located in local or external memory, e.g., main memory 106, or it can be recorded to external media, e.g., storage device 110 or server 130. The ledger 208 information can be retrieved by means of memory/device access via network interrogation or a separate internal task with external user interfaces.

In one current embodiment, i.e., a retail store bar code scanner, the target operating system used is Embedded Power Corporation's RTXC. The Interactive Configuration Utility and the On-line Analysis and Control Program are invoked by means of scanning a specific bar code tag sequence in order to select the information to be recorded, specify recording period/events and recording media, and controlling the reset/restart of recording.

The OSSPR 200 is invoked with each task switch caused by task-to-task communication or an interrupt. The task switch may occur when a lower priority task is preempted by the operating system for a higher priority task. At such time, the OSSPR 200 updates the ledger 208, described in detail below, with an event number, the identification of the last running task, the task priority and run-time, and the system times for each event. Also, the OSSPR 200 adjusts the task waiting count to reflect the number of tasks ready to run. After completing updates to the ledger 208, the OSSPR 200 returns control to the operating system kernel.

The On-line Analysis and Control Program uses the OSSPR 200 configuration information and the ledger 208 data to produce graphs and charts for the user to analyze the system's behavior. Furthermore, the output from the On-line Analysis and Control Program is formatted for the Operating Software Performance Monitor (OSPM) such that automatic adjustments to task priorities are made to improve system input/output throughput. By means of the Operating Software Performance Monitor 210, the user can select the conditions and/or time periods that certain tasks should run. The OSSPR's On-line Analysis and Control Program captures the results, which are accessible via reports.

Advantageously, the present invention provides a method and apparatus for monitoring and analyzing operating software program scheduling information and adjusting defined operating software parameters to modify system performance while the operating software is executing. Further advantageously, the present invention provides a mechanism to monitor, analyze, and adjust without requiring an external device or external software.

Further advantageously, the present invention analyzes and adjusts operating software performance without external device intervention while the operating software is operating. Further, the present invention provides feedback about operating software performance to a user or operating software without requiring an external device while the operating software is operating.

It will be readily seen by one of ordinary skill in the art that the present invention fulfills all of the objects set forth above. After reading the foregoing specification, one of ordinary skill will be able to affect various changes, substitutions of equivalents and various other aspects of the invention as broadly disclosed herein. It is therefore intended that the protection granted hereon be limited only by the definition contained in the appended claims and equivalents thereof.

What is claimed is:

1. A computer implemented method of controlling system performance comprising the steps of:
analyzing operating software program scheduling information; and
adjusting defined parameters to modify system performance.

2. The method as claimed in claim 1, wherein the defined parameters include at least one of scheduling priority, program termination, delayed restart, and program load leveling.

3. The method as claimed in claim 1, wherein the program scheduling information includes at least one of a count of the number of program schedules, a count of the number of program preempts, a count of the number of interrupts, a highest priority attained, a lowest priority attained, a program identity, a length of run-time, a count of the number of times in the idle loop, a count of the duration of the idle loop, a sequential record of scheduled programs, a sequential record of priorities, a sequential record of events, a count of the number of programs waiting to run per schedule time, and an identity of programs waiting to run per schedule time.

4. The method as claimed in claim 1, wherein said analysis step includes determining at least one of a system processing capability, a number of programs scheduled, a program run-time priority, a length of time each program executed, a number of preemptions, a number of interrupts, and an amount of idle time.

5. The method as claimed in claim 1, further comprising the step:
monitoring operating software scheduling information.

6. A computer system for capturing operating software scheduling information during execution of said operating software comprising:
a processor for receiving and transmitting data; and
a memory coupled to the processor, the memory having stored therein sequences of instructions which, when executed by the processor, cause the processor to analyze operating software scheduling information, and adjust defined parameters to modify system performance.

7. The computer system as claimed in claim 6, wherein the memory further includes sequences of instructions which, when executed by the processor, cause the processor to monitor operating software scheduling information.

8. The computer system as claimed in claim 6, wherein the defined parameters include at least one of scheduling priority, program termination, delayed restart, and program load leveling.

9. The computer system as claimed in claim 6, wherein the program scheduling information includes at least one of a count of the number of program schedules, a count of the number of program preempts, a count of the number of interrupts, a highest priority attained, a lowest priority attained, a program identity, a length of run-time, a count of the number of times in the idle loop, a count of the duration of the idle loop, a sequential record of scheduled programs, a sequential record of priorities, a sequential record of events, a count of the number of programs waiting to run per schedule time, and an identity of programs waiting to run per schedule time.

10. The computer system as claimed in claim 6, wherein the analysis includes determining at least one of a system processing capability, a number of programs scheduled, a program run-time priority, a length of time each program executed, a number of preemptions, a number of interrupts, and an amount of idle time.
